(19) United States
(12) Patent Application Publication
(10) Pub. No.: US 2008/0313478 A1
(43) Pub. Date: Dec. 18, 2008

(54) MECHANISM TO GATE CLOCK TRUNK AND SHUT DOWN CLOCK SOURCE

(76) Inventors: Wong Kar Leong, Teluk Intan (MY); Mikal Hunsaker, El Dorado Hills, CA (US)

Correspondence Address: INTEL CORPORATION;c/o INTELLEVATE, LLC, P.O. BOX 52050, MINNEAPOLIS, MN, 55402, US

(21) Appl. No.: 11/763,635

(22) Filed: Jun. 15, 2007

(51) Int. Cl. G06F 1/00

(52) U.S. Cl. 713/322

(57) ABSTRACT

An apparatus, method, and system are disclosed. In one embodiment, the apparatus includes a clock source unit that generates a clock signal, multiple clock trunk lines that supply the clock signal to multiple devices, and a clock control unit that instructs the clock source unit that can gate or supply the clock signal on the clock trunk lines.

### FIELD OF THE INVENTION

The invention relates to computer platform power reduction. More specifically, the invention relates to gating clock trunks and shutting down a clock source.

### BACKGROUND OF THE INVENTION

In a synchronous interconnect design, clocking logic is generally a high power consuming element. One or more phase lock loop (PLL) clock lines are normally associated with an interconnect to facilitate in data transfer timing. There are clock buffers to amplify the signal strength along the PLL lines coupling one component to another. Each buffer consumes power when the clock signal is active due to capacitive loads. Additionally, dynamic power consumption takes place at any coupling of a device to the interconnect. Dynamic power is a direct result of switching activity at the input and output of a gate. Switching activity refers to the charging (to Vdd; i.e. the positive supply voltage) and discharging (to Vss; i.e. ground or negative supply) of each wire capacitance of an interconnect resulting in the transmission of either ones or zeros across the interconnect. Total Dynamic power consists of output load switching power (due to charging and discharging the output load capacitances), short-circuit power (due to finite rise and fall time of the input signal resulting in direct current path from Vdd to Vss) and internal switching power (due to charging and discharging of internal gate capacitances).

Currently, some I/O devices, that are coupled to an interconnect, can gate the clock they receive from the interconnect, but this does not reduce power consumption on the clock trunk line(s) from the interconnect controller to these devices. Also, there are controllers that are capable of shutting down the entire clock generation unit within the controller altogether, but this causes significant delays in spinning up the clock to become usable again.

### BRIEF DESCRIPTION OF THE DRAWINGS

The present invention is illustrated by way of example and is not limited by the drawings, in which like references indicate similar elements, and in which:

FIG. 1 describes one embodiment of an apparatus and system for gating clock trunks and shutting down the clock source.

FIG. 2 is a circular flow diagram of one embodiment of a process to allow the gating of a clock trunk line as well as to allow the power down of a clock generator.

FIG. 3 is a circular flow diagram of one embodiment of a process to allow the gating of multiple clock trunk lines as well as to allow the power down of a clock generator.

### DETAILED DESCRIPTION OF THE INVENTION

Embodiments of an apparatus, method, and system to gate clock trunks and shut down the clock source are described. In the following description, numerous specific details are set forth. However, it is understood that embodiments may be practiced without these specific details. In other instances, well-known elements, specifications, and protocols have not been discussed in detail in order to avoid obscuring the present invention.

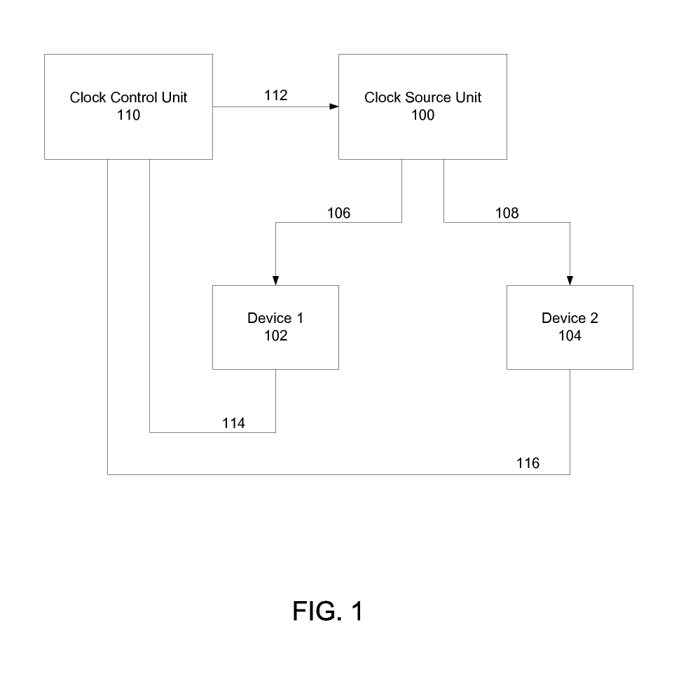

FIG. 1 describes one embodiment of an apparatus and system for gating clock trunks and shutting down the clock source. In many embodiments, the apparatus and system reside within a computer system. The computer system may include one or more central processing units, a chipset, system memory, a graphics subsystem, and one or more interconnects coupling the aforementioned devices to one another. The entire computer system is not shown within FIG. 1. Rather, FIG. 1 describes the specific apparatus and clocking subsystem within the larger computer system. Though, in other embodiments, the apparatus and system described in FIG. 1 may be included within a larger system different from the standard computer system described above, such as within a handheld device.

Returning to FIG. 1, in many embodiments, an interconnect coupling one or more devices to a chipset may be controlled by an interconnect controller. For example, in many modern chipsets a PCI Express controller is located within the I/O controller hub portion of the chipset. In some embodiments, a phase lock loop (PLL) clock originating from the I/O controller hub can be utilized to generate clocks for PCI Express functions as well as the backbone clock in the I/O Controller Hub. In some embodiments, this PLL clock may be the direct media interface (DMI) PLL that serves as the PLL for the DMI interconnect that couples the I/O Controller Hub to a Memory Controller Hub portion of the chipset. In these embodiments, without any power savings methodologies, a device coupled to the PCI Express interconnect (such as an I/O Controller Hub internal PCI Express function) receives the DMI PLL clock even if the device is idle and performing no work. Thus, any power consumed by providing the clock signal to the device is wasted when the device is idle. In some embodiments, a device may implement aggressive clock gating logic when it is idle, which will lower the power consumption of the device itself. However, the power consumed by the clock trunk is still wasted.

In many embodiments, an I/O Controller Hub contains a clock source unit 100 that produces a clock signal. In other embodiments, the clock source unit is located within a device other than an I/O Controller Hub. The clock signal comprises an alternating signal from a positive supply voltage to a negative supply voltage (or ground). The clock signal will alternate at a specific frequency. In some embodiments, this clock signal is created by a piezoelectric crystal coupled directly to the I/O Controller Hub. In other embodiments, the clock signal is received from a supplied reference clock signal input to the I/O Controller Hub from an additional interconnect. In many embodiments, the Clock Source Unit 100 generates a PLL clock signal. In some embodiments, the generation of the clock signal may comprise creating the clock signal using a piezoelectric crystal and distributing the signal to any device or interconnect requiring the clock signal frequency. In other embodiments, generating the clock signal comprises receiving the clock signal from an external source and redistributing the signal to any device or interconnect requiring the clock signal frequency.

In many embodiments, the PLL clock signal is distributed to Device 1 (102) and Device 2 (104) from the Clock Source Unit 100 across clock trunk line 1 (106) and clock trunk line 2 (108) respectively. Although, the PLL clock signal itself is one signal only, the layout of clock trunk line 1 (106) and clock trunk line 2 (108) allows for the signal to be sent across one clock trunk line and not the other. Thus, the two clock trunk lines are able to operate independently of one another.

In many embodiments, a device, such as Device 1 (102) or Device 2 (104), may implement aggressive clock gating within the device itself. When some portion of the device is idle, the device can clock gate that portion of the device to reduce a portion of the device's power consumption. When the portion requires the clock again, the clock is supplied to this portion of logic again. The latency of controlling this type of aggressive clock gating is minimal and typically the device is supplied the clock again on the next clock.

Additionally, in many embodiments, Clock Control Unit 110 contains logic to instruct the Clock Source Unit 100 whether to gate a given clock trunk line or supply the clock signal across the given clock trunk line. Gating a clock trunk line refers to not allowing the clock signal to be supplied across the clock trunk line, and, therefore, allowing the clock trunk line to remain in a steady state instead of an alternating state. This steady state will reduce power consumption across the entire clock trunk. For example, Device 2 (104) may be operational and receiving data synchronously over an interconnect. In this operational state Device 2 (104) may require the PLL clock signal from the Clock Source Unit 100 to operate correctly. In this example, Clock Control Unit 110 will instruct Clock Source Unit 100 to supply the PLL clock signal to Device 2 (104) across clock trunk line 2 (108). At the same time, Device 1 is idle and may enable device-specific aggressive clock gating, thus, the device would not require the PLL clock signal. Thus, in this example, Clock Control Unit 110 will instruct Clock Source Unit 100 to gate the PLL clock signal to Device 1 (102) to reduce the power consumption across the clock trunk, on top of the aggressive clock gating within Device 2 (102). In many embodiments, Clock Control Unit 110 will issue instructions to Clock Source Unit 100 over interconnect 112. In other embodiments, Clock Control Unit 110 and Clock Source Unit 100 are integrated (these embodiments are not shown in FIG. 1).

Additionally in FIG. 1, interconnects 114 and 116 allow communication to take place from Devices 1 and 2 (102 and 104) to Clock Control Unit 110. In different embodiments, interconnects 114 and 116 may allow transport of one or more than one signal. In many embodiments, a communication protocol between a given device and the Clock Control Unit is defined. In many embodiments, each device outputs two signals, a clock_gate signal and a clock_wake signal. The clock_gate signal is used to signify that the device does or does not require the PLL clock signal while the device is still receiving the PLL clock signal. Whereas, the clock_wake signal is used to signify that the device requires the PLL clock signal in the absence of the PLL clock signal. In many embodiments, each device will have some form of free and independent clock to allow assertion of the clock_wake signal in the absence of the PLL clock signal. In another embodiment, each device outputs a single clock_gate signal. In this embodiment, assertion of the clock_gate signal indicates the device does not require the PLL clock, and de-assertion indicates the device requires the PLL clock.

In FIG. 1, the Clock Control Unit 110 monitors Devices 1 and 2 (102 and 104) through interconnects 114 and 116 respectively. Though, in other embodiments, there may be more devices and, thus, Clock Control Unit 110 would be monitoring additional devices. The Clock Control Unit 110 will initiate the gating of a specific clock trunk when the device connected to that clock trunk has asserted the clock_gate signal. Once the Clock Control Unit 110 sees the clock_gate signal assert for a particular device, it instructs the Clock Source Unit 100 to gate the corresponding trunk line. This clock trunk gating instruction may not be as immediate as the device-specific aggressive clock gating because the clock trunk gating instruction would need to be synchronized to the clock source logic.

In other embodiments, clock trunk lines 106 and 108 are not independent of each other. Rather, Clock Source Unit 100 outputs one PLL clock signal on one clock trunk line and the trunk line branches out to the multiple devices from one common source portion of the line. Thus, in these embodiments, the trunk line may only be gated when all devices assert the clock_gate signal. In these embodiments, the Clock Control Unit 110 will additionally have a clock_gate_ultimate signal to send back to Devices 1 and 2 (102 and 104) across interconnects 114 and 116 respectively. The clock_gate_ultimate signal signifies to devices that the PLL clock signal they are being supplied with will soon be gated. In another embodiment, the PLL clock can be gated immediately upon the assertion of the clock_gate_ultimate signal when the clock trunk is short.

For example, in some embodiments, once the Clock Control Unit 110 receives the clock_gate signal from all connected devices, it may enter a grace period (e.g. a 16 clock period) where any device can deassert it's clock_gate signal and the Clock Control Unit 110 will subsequently not instruct the Clock Source Unit 100 to gate the PLL clock signal. If the grace period expires without any device deasserting the clock_gate signal, then the Clock Control Unit 110 will assert the clock_gate_ultimate signal to notify all devices that the PLL clock signal will disappear soon. Once the clock_gate_ultimate signal has been asserted, any device that subsequently wants to wake up the clock and receive the PLL clock signal must assert the clock_wake signal in their own clock domain to wake up the PLL clock signal. The device cannot proceed with the wake event using the PLL even though it may still be running because it may disappear at any time after the clock_gate_ultimate signal has been asserted. In another embodiment, the PLL clock may be gated at the device 1 (102) and device 2 (104) input upon clock_gate_ultimate signal assertion to prevent the device from servicing the wake event.

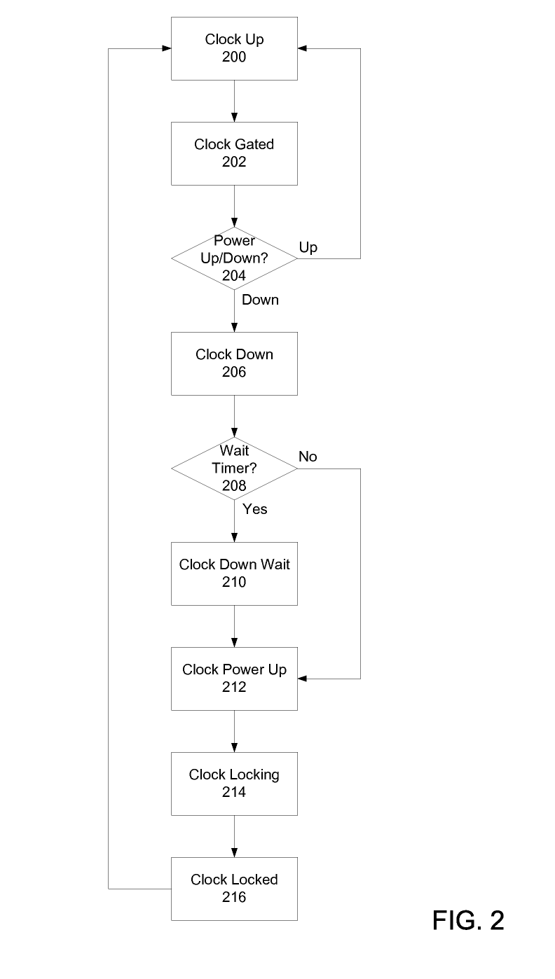

In some embodiments, if all clock trunk lines are gated, the generation of the PLL clock signal itself within the Clock Source Unit 110 may be shut down to reduce power consumption further. In many embodiments, the shutdown of the generation of the PLL clock signal may occur after a pre-programmed idle time (i.e. where all clock trunk lines are gated) without any wake event. The same clock_wake signal may be used to wake up the PLL clock signal generation within the Clock Source Unit 110, though the wake event requires additional time beyond the time required to stop the gating of a clock trunk line because there are additional steps required to initialize and lock in the frequency of a PLL (discussed in detail in FIG. 2).

FIG. 2 is a circular flow diagram of one embodiment of a process to allow the gating of a clock trunk line as well as to allow the power down of a clock generator. The process is performed by processing logic that may comprise hardware (circuitry, dedicated logic, etc.), software (such as is run on a general purpose computer system or a dedicated machine), or a combination of both. Referring to FIG. 2, the process begins by processing logic maintaining an operational clock (Clock Up—processing block 200). Next, in response to one or more clock_gate assertions by one or more devices, processing logic gates the clock (Clock Gated—processing block 202).

The gated state will remain until one of two changes take place. Either a device will assert the clock_wake signal, in which case the clock will return to a power up state, or no assertions of the clock_wake signal take place over the course of pre-programmed idle time, in which case the clock will go down, which means the Clock Source Unit (100 in FIG. 1) will cease to generate the PLL clock signal. Processing logic determines which of these two states occurs (Power Up/Down—processing block 204). If a clock_wake assertion occurs, then processing logic returns to processing block 200 and operates with the clock up. If a clock_wake assertion does not occur and the pre-programmed idle time expires, then processing logic brings the clock generation down (Clock Down—processing block 206).

The clock down state will remain until a power up event occurs (e.g. at least one device asserts the clock_wake signal). Once a wake event is detected, the clock source will go through a power up sequence. In some embodiments, once the clock is down, processing logic must determine if a clock down wait period exists (processing block 208). If a wait period exists, then processing logic goes into a clock down wait period (Clock Down Wait—processing block 210). Otherwise, if a wait period does not exist, then processing logic proceeds to the Clock Power Up state (Clock Power Up—processing block 212). If a wait period existed, then processing logic can only enter the Clock Power Up state after the Clock Wait State has completed. Once the Clock Source Unit (100 in FIG. 1) has powered up the clock generation, then processing logic must lock the clock into a set frequency. The Clock Locking block is the state in which processing logic is attempting to lock the PLL clock signal (Clock Locking—processing block 214). Once the clock has been locked (Clock Locked—processing block 216), processing logic returns to the clock up state (processing block 200) and the process has completed a full loop. This loop may repeat many times.

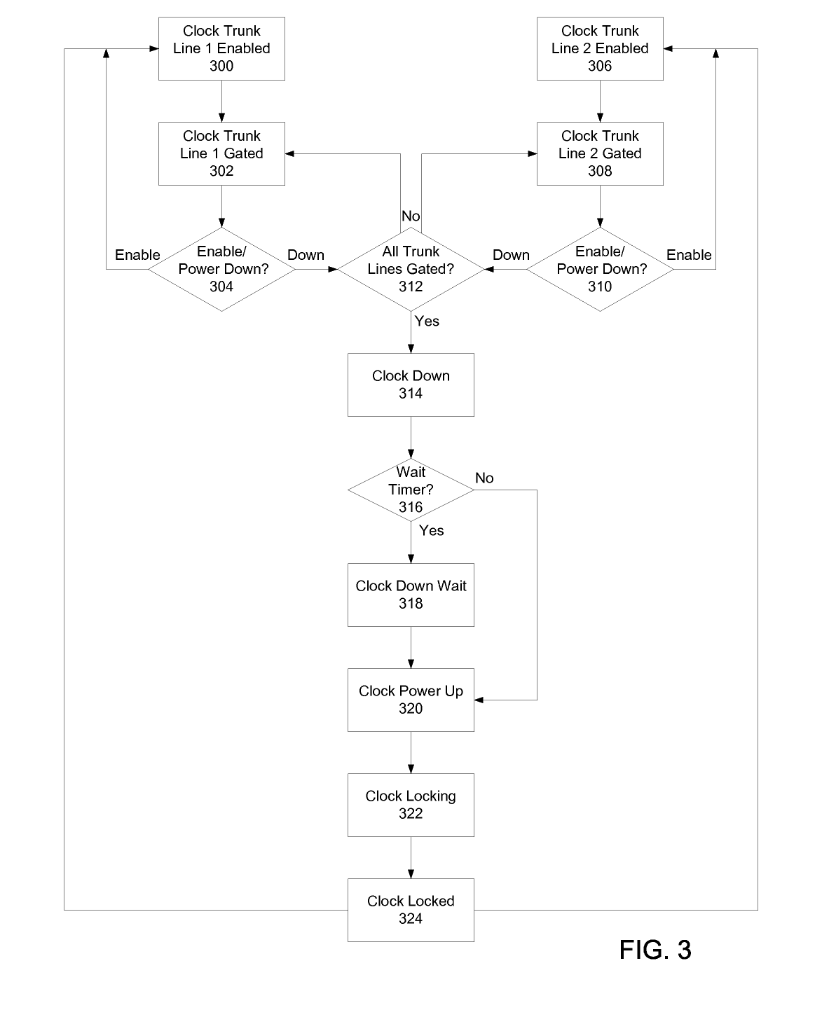

While FIG. 2 described the process of gating a single clock trunk line, FIG. 3 describes the process of gating multiple clock trunk lines. Specifically, FIG. 3 is a circular flow diagram of one embodiment of a process to allow the gating of multiple clock trunk lines as well as to allow the power down of a clock generator. The process is performed by processing logic that may comprise hardware (circuitry, dedicated logic, etc.), software (such as is run on a general purpose computer system or a dedicated machine), or a combination of both. Referring to FIG. 3, the process begins by processing logic enabling a first clock trunk line (Clock Trunk Line 1 Enabled—processing block 300). Next, in response to a device coupled to the first clock trunk line asserting the clock_gate signal, processing logic gates the PLL clock signal on the first clock trunk line (Clock Trunk Line 1 Gated—processing block 302).

The gated state of the first clock trunk line will remain until one of two changes take place. Either the device coupled to the first clock trunk line will assert the clock_wake signal, in which case the first clock trunk line will be re-enabled, or the device coupled to the first clock trunk line will not assert the clock_wake signal over the course of pre-programmed idle time, in which case the first clock trunk line will be in a state that would allow the clock to go down, which means the Clock Source Unit (100 in FIG. 1) will cease to generate the PLL clock signal. Processing logic determines which of these two states occurs (Enable/Power Down—processing block 304). If a clock_wake assertion occurs, then processing logic returns to processing block 300 and operates with the clock up and clock trunk line 1 enabled. If a clock_wake assertion does not occur and the pre-programmed idle time expires, then processing logic goes to a second state requirement for a multiple trunk line and multiple device embodiment. Namely, processing logic must determine whether all trunk lines are gated (processing block 312).

In the embodiment illustrated in FIG. 3, a second clock trunk line exists with a device coupled to it. In this embodiment, processing logic also enables a second clock trunk line (Clock Trunk Line 2 Enabled—processing block 306). Next, in response to a device coupled to the second clock trunk line asserting the clock_gate signal, processing logic gates the PLL clock signal on the second clock trunk line (Clock Trunk Line 2 Gated—processing block 308).

The gated state of the second clock trunk line will remain until one of two changes take place. Either the device coupled to the second clock trunk line will assert the clock_wake signal, in which case the second clock trunk line will be re-enabled, or the device coupled to the second clock trunk line will not assert the clock_wake signal over the course of pre-programmed idle time, in which case the second clock trunk line will be in a state that would allow the clock to go down, which means the Clock Source Unit (100 in FIG. 1) will cease to generate the PLL clock signal. Processing logic determines which of these two states occurs (Enable/Power Down—processing block 310). If a clock_wake assertion occurs, then processing logic returns to processing block 300 and operates with the clock up and clock trunk line 2 enabled. If a clock_wake assertion does not occur and the pre-programmed idle time expires, then processing logic goes to a second state requirement for a multiple trunk line and multiple device embodiment. Namely, processing logic must determine whether all trunk lines are gated (processing block 312) as stated previously.

In the embodiment illustrated in FIG. 3, if both clock trunk lines are gated and the processing logic reaches processing block 312, then processing logic will take the clock down (processing block 314). Otherwise, if one of the two trunk lines are not gated, then processing logic will return to the clock trunk line gated state on the one line that is gated (processing block 302 or 308). In some embodiments, the idle timer is reset and begins the count again.

The clock down state will remain until a power up event occurs (e.g. at least one device asserts the clock_wake signal). Once a wake event is detected, the clock source will go through a power up sequence. In some embodiments, once the clock is down, processing logic must determine if a clock down wait period exists (processing block 316). If a wait period exists, then processing logic goes into a clock down wait period (Clock Down Wait—processing block 318). Otherwise, if a wait period does not exist, then processing logic proceeds to the Clock Power Up state (Clock Power Up—processing block 320). If a wait period existed, then processing logic can only enter the Clock Power Up state after the Clock Wait State has completed. Once the Clock Source Unit (100 in FIG. 1) has powered up the clock generation, then processing logic must lock the clock into a set frequency. The Clock Locking block is the state in which processing logic is attempting to lock the PLL clock signal (Clock Locking—processing block 322). Once the clock has been locked (Clock Locked—processing block 324), processing logic returns to the clock trunk line enabled states (processing block 300 for trunk line 1 and processing block 306 for trunk line 2) and the process has completed a full loop. Again, this loop may repeat many times.

Thus, embodiments of an apparatus, method, and system to gate clock trunks and shut down the clock source are described. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. An apparatus, comprising:
a clock source unit to generate a clock signal;
a plurality of clock trunk lines coupled to the clock source unit, each clock trunk line to supply the clock signal to one of a plurality of devices; and
a clock control unit to instruct the clock source unit to gate or supply the clock signal on each of the plurality of clock trunk lines.

2. The apparatus of claim 1, wherein the clock control unit is further operable to:
receive instruction from a first device of the plurality of devices whether the first device requires the supplied clock signal.

3. The apparatus of claim 2, wherein the clock control unit is further operable to:
instruct the clock source unit to gate the clock signal on the trunk line supplying the first device when the first device instructs the clock control unit that it does not require the clock signal; and
instruct the clock source unit to supply the clock signal on the trunk line supplying the first device when the first device instructs the clock control unit that it requires the clock signal.

4. The apparatus of claim 1, further comprising:
the clock control unit to instruct the clock source unit to shutdown the generation of the clock signal when all of the plurality of the clock trunk lines are gated; and
the clock source unit to shutdown the generation of the clock signal when instructed by the clock control unit.

5. The apparatus of claim 4, further comprising:
the clock control unit to instruct the clock source unit to initiate a wake up procedure to begin generation of the clock signal when at least one clock trunk line is not gated, if the clock source unit currently is not generating the clock signal; and
the clock source unit to initiate the wake up procedure to begin generation of the clock signal when instructed.

6. A method, comprising:
generating a clock signal;
supplying a clock signal to a plurality of devices, wherein each of the plurality of devices is supplied the clock signal on a clock trunk line;
gating the clock signal on the clock trunk line to each device that does not require the clock signal; and
supplying the clock signal on the clock trunk line to each device that does require the clock signal.

7. The method of claim 6, further comprising:
receiving instruction from a first device of the plurality of devices whether the first device requires the supplied clock signal.

8. The method of claim 6, further comprising:
shutting down the generation of the clock signal when all of the plurality of the clock trunk lines are gated.

9. The method of claim 8, further comprising:
initiating a wake up procedure to begin generation of the clock signal when at least one clock trunk line is not gated, if the clock signal is not currently being generated.

10. A system, comprising:
a clock source unit to generate a clock signal;
a first device;
a first clock trunk line coupled to the clock source unit to supply the clock signal to the first device;
a clock control unit to instruct the clock source unit to gate or supply the clock signal on the first clock trunk line.

11. The system of claim 10, wherein the clock control unit is further operable to:
receive instructions from the first device whether the first device requires the supplied clock signal.

12. The system of claim 11, wherein the clock control unit is further operable to:
instruct the clock source unit to gate the clock signal on the trunk line supplying the first device when the first device instructs the clock control unit that it does not require the clock signal; and
instruct the clock source unit to supply the clock signal on the trunk line supplying the first device when the first device instructs the clock control unit that it requires the clock signal.

13. The system of claim 10, further comprising:
the clock control unit to instruct the clock source unit to shutdown the generation of the clock signal when all of the plurality of the clock trunk lines are gated; and
the clock source unit to shutdown the generation of the clock signal when instructed by the clock control unit.

14. The system of claim 13, further comprising:
the clock control unit to instruct the clock source unit to initiate a wake up procedure to begin generation of the clock signal when at least one clock trunk line is not gated, if the clock source unit currently is not generating the clock signal; and
the clock source unit to initiate the wake up procedure to begin generation of the clock signal when instructed.

15. The system of claim 10, further comprising:
the clock source unit to supply the clock signal to first device and to gate the clock signal to the second device.

16. The system of claim 10, further comprising:
the clock source unit to supply the clock signal to the second device and to gate the clock signal to the first device.
